(19) United States
(12) Patent Application Publication
(10) Pub. No.: US 2024/0044385 A1
(43) Pub. Date: Feb. 8, 2024

(54) ACTUATOR WITH INTEGRATED PARKING BRAKE

(71) Applicant: SAFRAN LANDING SYSTEMS, Velizy-Villacoublay (FR)

(72) Inventors: Nathanael RICHARD, MOISSY-CRAMAYEL (FR); Romain PRESLE, MOISSY-CRAMAYEL (FR); Laurent SCHWARTZ, MOISSY-CRAMAYEL (FR); Mathieu GENGOUX, MOISSY-CRAMAYEL (FR)

(73) Assignee: SAFRAN LANDING SYSTEMS, Velizy-Villacoublay (FR)

(21) Appl. No.: 18/266,382

(22) PCT Filed: Dec. 1, 2021
(86) PCT No.: PCT/EP2021/083830

§ 371 Date: Jun. 9, 2023

(30) Foreign Application Priority Data
Dec. 10, 2020 (FR) 20 13009

(51) Int. Cl. F16D 65/18; B64C 25/44

(52) U.S. Cl. CPC F16D 65/18; B64C 25/44; F16D 2121/24

(57) ABSTRACT

A motor sub-assembly for an electromechanical brake actuator of an aircraft wheel includes a casing, a shaft mounted in the casing, and an electric motor mounted in the casing rotate the shaft, the shaft having an end connected to a screw-and-nut assembly to exert a force on a stack of disks for braking the aircraft wheel. The shaft has a first set of teeth and the motor sub-assembly has a shuttle mounted to slide relative to the casing and provided with a second set of teeth. The motor sub-assembly includes a selector mechanism that moves the shuttle selectively between first and second positions in which the first set of teeth is engaged and disengaged with the second set of teeth, respectively. The motor sub-assembly includes a holder device that holds the shuttle in the first position and a locking device that continuously prevents the shuttle from rotating relative to the casing.

### FIELD OF THE INVENTION

The invention relates to the field of braking aircraft wheels.

### BACKGROUND OF THE INVENTION

It is known to ensure braking of aircraft wheels by means of an electromagnetic braking actuator that moves a pusher so as to exert compressive force on a stack of disks comprising rotor disks constrained in rotation with the wheel and a stator disks constrained in rotation with the axle on which the wheel is rotatably mounted. The actuator generally comprises an electric motor for rotating an output shaft that is connected to a device for converting the movement in rotation of the output shaft into movement in translation of the pusher.

When the aircraft is parked, the compression force needs to be maintained on the stack of disks.

It is also known for the electromagnetic braking actuator to be fitted with a fail-safe parking brake that locks the shaft of the actuator motor when it is no longer powered and that unlocks the shaft as soon as the electric motor is powered. Such a parking brake needs to be powered for a considerable length of time while the electromagnetic actuator is in operation (i.e. during stages of landing, taxiing, and take-off). This increases the overall electricity consumption of the braking system and causes the coil of the parking brake to get hot. Furthermore, in the event of the parking brake failing, it remains engaged and applies the compression force continuously, which leads to premature wear of the stack of disks in the event of the aircraft taxiing with the brake locked, and can lead to the braking system being destroyed.

Improvements are described in Document FR-A-3 018 880.

### OBJECT OF THE INVENTION

An object of the invention is to further improve brake actuators, in particular to reduce electricity consumption and to improve reliability.

### SUMMARY OF THE INVENTION

To this end, there is provided a motor sub-assembly for an electromechanical brake actuator of an aircraft wheel. The actuator comprises a casing, a shaft mounted in the casing to rotate about a longitudinal axis of the shaft, and an electric motor mounted in the casing and connected to a first end of the shaft in order to drive the shaft in rotation. The shaft has a second end arranged to be functionally connected to a movable element of a screw-and-nut assembly in order to exert a force on a stack of disks for braking the wheel. The shaft has a first set of teeth and the actuator has a shuttle mounted to slide relative to the casing and provided with a second set of teeth for co-operating with the first set of teeth. The actuator further comprises a selector mechanism for selectively moving the shuttle between a first position in which the first set of teeth is engaged with the second set of teeth and a second position in which the first set of teeth is disengaged from the second set of teeth. The actuator further comprises a holder device for holding the shuttle in its first position and a locking device for continuously preventing the shuttle from rotating relative to the casing.

In the meaning of the present application, a device for continuously preventing the shuttle from rotating means that the device is not declutchable.

An actuator motor sub-assembly is thus obtained that enables a brake pusher to be held stationary without requiring electrical energy to remain in this state. Such an actuator motor sub-assembly can be installed in lubricated surroundings, unlike friction brake devices, which means there is no need to provide sealed compartments in the actuator, thereby improving the costs of manufacturing such an actuator.

A device that is particularly inexpensive is obtained when the shuttle is mounted on the shaft to provide a sliding and pivoting connection relative to the shaft. Specifically, such a connection is simpler and less expensive to make than is a slideway connection.

The weight of the equipment is reduced when the selector mechanism comprises a coil.

The actuator motor sub-assembly is easier to manufacture when the locking device for continuously preventing the shuttle from rotating relative to the casing comprises at least one guide secured to the casing and on which the shuttle is guided to slide along a direction substantially parallel to the longitudinal axis.

The lifetime of the actuator motor sub-assembly is improved when the shuttle comprises a first portion made of non-ferromagnetic material and a second portion made of ferromagnetic material.

Advantageously, the actuator motor sub-assembly further comprises a device for holding the shuttle in its second position.

Advantageously, the device for holding the shuttle in its first position comprises a permanent magnet and/or the device for holding the shuttle in its second position comprises a permanent magnet.

A torque-limiting function is obtained when the first set of teeth and/or the second set of teeth includes a face lying in a first plane intersecting the longitudinal axis, the first angle between the first plane and the longitudinal axis lying in the range 5° to 85°. It should be recalled that, in conventional manner, the angle between the first plane and the longitudinal axis corresponds to the (unsigned) angle that the longitudinal axis makes with its orthogonal projection onto the first plane.

Also advantageously, the electric motor is located in the casing between the shuttle and the output of the actuator.

The invention also provides an actuator including a motor sub-assembly of the above-mentioned type, a braking system including such an actuator, and an aircraft including such a braking system.

Other characteristics and advantages of the invention appear on reading the following description of particular, nonlimiting embodiments of the invention.

### BRIEF DESCRIPTION OF THE DRAWINGS

Reference is made to the accompanying figures, in which:

FIG. 1 is a diagrammatic view of a braking system of the invention;

FIG. 2 is a diagrammatic section view of an actuator in a first embodiment of the invention, while in a first state;

FIG. 3 is a diagrammatic view of the FIG. 2 actuator in cross section on a plane III-III;

FIG. 4 is a diagrammatic section view of the FIG. 2 actuator while in a second state;

FIG. 5 is a diagrammatic section view of the FIG. 2 actuator while in an intermediate, third state; and

FIG. 6 is a diagrammatic view of an actuator in a second embodiment of the invention while in the first state.

### DETAILED DESCRIPTION OF THE INVENTION

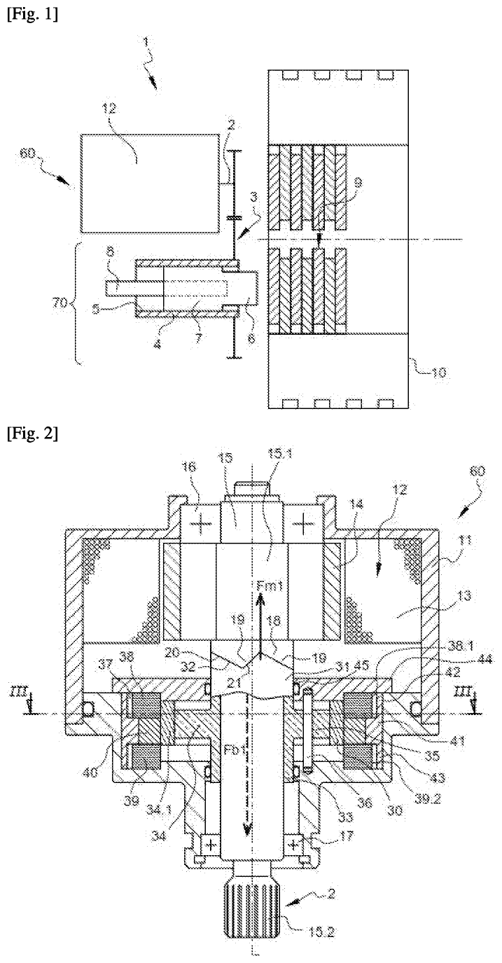

With reference to FIGS. 1 to 6, the invention relates to a system for braking a wheel 10 of an aircraft (not shown).

The braking system includes an electromagnetic brake actuator, given overall reference 1, that is arranged to exert a compression force on a stack of disks 9 comprising rotor disks constrained in rotation with the wheel and stator disks constrained in rotation with the axle (not shown) on which the wheel is mounted to rotate.

The electromagnetic actuator comprises a motor sub-assembly 60 and a brake actuator sub-assembly 70. The motor sub-assembly 60 comprises an electric motor 12 having an output shaft 2 that is connected to the brake-actuator sub-assembly 70 by a gear train 3. The brake-actuator sub-assembly 70 comprises a nut 4 that is mounted to be stationary in translation and free to move in rotation under rotary drive from the gear train 3. The nut 4 has a thread 5. A pusher 6 is constrained to move in translation with a ball-screw 7 that co-operates with the thread 5. The screw 7 is fitted with anti-rotation means (specifically a central guide 8) so that rotation of the nut 4 drives movement in translation of the screw 7 and thus of the pusher 6. The pusher 6 thus acts on command to exert a compression force on the stack of disks 9. This arrangement is itself known and it is not described in greater detail herein.

As can be seen in FIG. 2, the motor sub-assembly 60 includes a casing 11 enclosing the electric motor 12, which is connected to an electronic braking control unit (not shown) having an electronic circuit controlling an electronic power circuit powering the motor 12. The motor 12 comprises a stator 13 fastened to the casing 11 and a rotor 14 secured to a first end 15.1 of a shaft 15 that is mounted in the casing 11 to rotate about a longitudinal axis Oy by means of first and second bearings 16 and 17. The shaft 15 has a second end 15.2 that projects outside the casing 11 and that has teeth for constituting the output 2 of the motor sub-assembly 60. The shaft 15 is provided with a first set of teeth 18 having three teeth 19. The teeth 19 are triangular, and they are defined by faces 20 and 21 lying in respective planes that do not contain the longitudinal axis Oy (in other words planes that intersect the axis Oy) and that are not perpendicular to said axis.

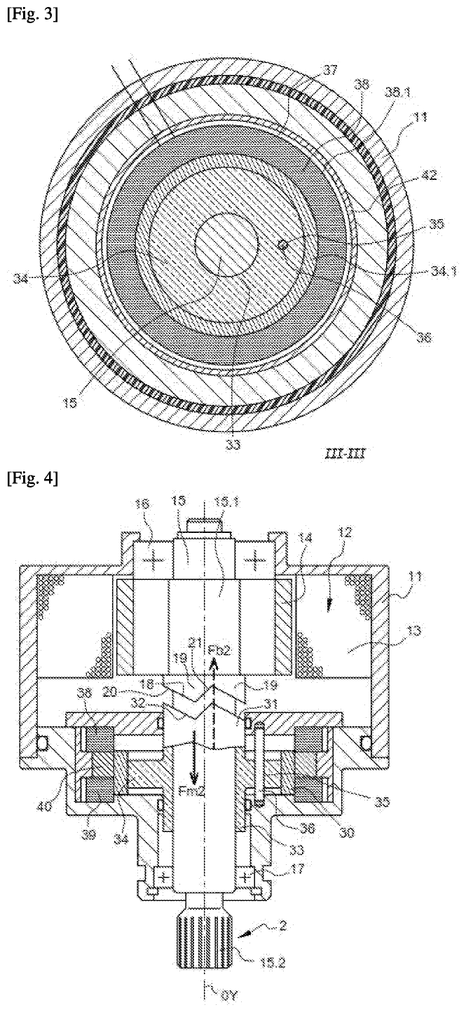

A shuttle 30 is mounted on the shaft 15 to provide a sliding and pivoting connection relative to the shaft 15 and to provide a slideway connection relative to the casing 11 (i.e. a sliding-only connection). At its first end 31, the shuttle 30 is provided with a second set of teeth 32 suitable for co-operating with the first set of teeth 18. As can be seen in FIG. 2, the shuttle 30 is positioned in the casing 11 between the motor 12 and the outlet 2. As can be seen in FIG. 3, the shuttle 30 has a central first portion 33 that is cylindrical and tubular, that is made of bronze, and that has a collar 34, also made of bronze, projecting radially therefrom. The central first portion 33 is smooth and it extends around a smooth portion of the shaft 15. A ring 34.1 of ferromagnetic material, specifically ferrite, lies at the periphery of the collar 34. The collar 34 includes a hole 35 that receives a steel guide 36 secured to the casing 11 and on which the shuttle 30 is guided to slide along a direction that is substantially parallel to the longitudinal axis Oy. The guide 36 and the hole 35 constitute a locking device continuously preventing the shuttle 30 from rotating relative to the casing 11. The casing 11 defines a housing 37 that receives a first coil 38 situated beside the motor 12 and a second coil 39 situated beside the output 2, which coils are spaced apart from each other by a permanent magnet 40. The permanent magnet 40 is held in place by an annular support 41 made of ferromagnetic material and having first and second flanges 42 and 43. The first flange 42 faces a first outer flank 38.1 of the first coil 38. The second flange 43 faces a second outer flank 39.2 of the second coil 39. The first and second coils 38 and 39 are electrically connected to the electronic braking control unit. The housing 37 is closed by a lid 44 made of ferromagnetic material and having an opening 45 for passing the shaft 15.

The shuttle 30 can adopt two extreme positions, namely:
a first position, as shown in FIG. 2, in which the collar 34 is closer to the first coil 30 and the first set of teeth 38 is engaged with the second set of teeth 32; and
a second position, as shown in FIG. 4, in which the collar 34 is closer to the second coil 39 and the first set of teeth 18 is disengaged from the first set of teeth 32.

Thus, when the shuttle 30 is in its first position, it is constrained in rotation with the shaft 15 by the first and second sets of teeth 18 and 32. Since the shuttle is continuously locked against rotating relative to the casing 11, the shaft 15 is locked against rotating relative to the casing 11. When the shuttle 30 is in its second position, the shaft 15 is free to rotate about the longitudinal axis Oy relative to the casing 11. The permanent magnet 40 and the ferrite ring 34.1 have respective polarities and dimensions such that the shuttle 30 is held in its first position by the permanent magnet 40 exerting a first magnetic force Fm1. In the same manner, in the absence of the first and second coils 38 and 39 being powered, the shuttle 30 is held in its second position by the permanent magnet 40 exerting a second magnetic force Fm2.

In operation, when the pilot of the aircraft issues a braking command, the electronic braking control unit powers the upper and lower coils 38 and 39 so that they exert a second magnetic force Fb1 on the ring 34.1 that is sufficient to overcome the first magnetic force Fm1 and move the shuttle 30 towards its second position (FIG. 2). When the electronic braking control unit stops powering the upper and lower coils 38 and 39, the shuttle 30 is held in its second position (FIG. 4) under the effect of the permanent magnet 40 with its field lines being looped through the ring 34.1, the casing 11, and the second flange 43 of the support 41. The electronic braking control unit can then cause the motor 12 to be powered so as to apply a compression force on the stack of disks 9 in conventional manner in order to be able to stop the aircraft while taxiing. Once the aircraft has come to rest in its parking position, the electronic braking control unit controls the motor 12 so that it applies a compression force for holding the aircraft in position. The electronic braking control unit then powers the upper and lower coils 38 and 39 so that they apply a second magnetic force Fb2 on the ring 34.1 that is sufficient to return the shuttle 30 towards its first position (FIG. 4). When the electronic braking control unit stops powering the upper and lower coils 38 and 39, the shuttle 30 is held in its first position (FIG. 2) under the effect of the permanent magnet 40 with its field lines being looped through the ring 34.1, the lid 44, and the first flange 42 of the support 41. In this first position, the shaft 15 is locked against rotation, and the force applied by the pusher 6 is maintained. After a suitable time delay, the electronic braking control unit stops powering the motor 12 and, without consuming energy, the motor sub-assembly acts to apply a compression force for holding the aircraft in position (i.e. a parking force).

This procures a brake actuator with reduced electricity consumption.

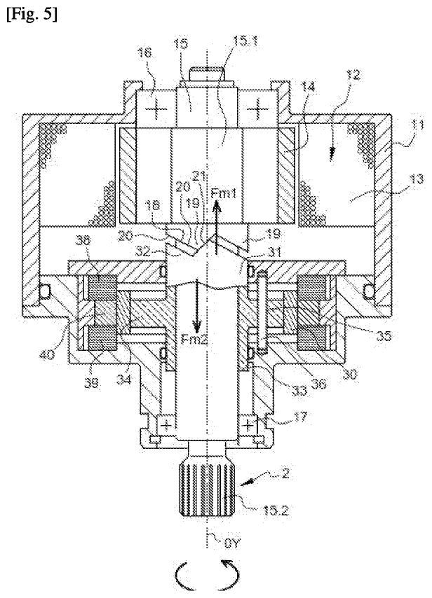

When the stack of disks 9 applies an opposing force on the pusher 6 that is greater than the braking force, e.g. as a result of phenomena associated with thermal expansion/contraction of the brake after braking, this opposing force greater than the braking force gives rise to an opposing torque being applied to the shaft 15 via the drive train connecting together the pusher 6 and the shaft 15 (FIG. 5). When the opposing torque exceeds a predetermined threshold value, the force applied by the first set of teeth 18 on the second set of teeth 32 is sufficient to overcome the first magnetic force Fm1 and thus push back the shuttle 30 (FIG. 5), allowing the shaft 15 to rotate relative to the casing 11, thereby acting as a limiter of the torque applied to the motor sub-assembly 60. The opposing torque decreases progressively as the shaft 15 rotates. On going below a threshold, the opposing torque is no longer sufficient to overcome the first magnetic force Fm1, and the shuttle 30 goes back to its first position. This re-engagement corresponds to the aircraft having its parking brake applied.

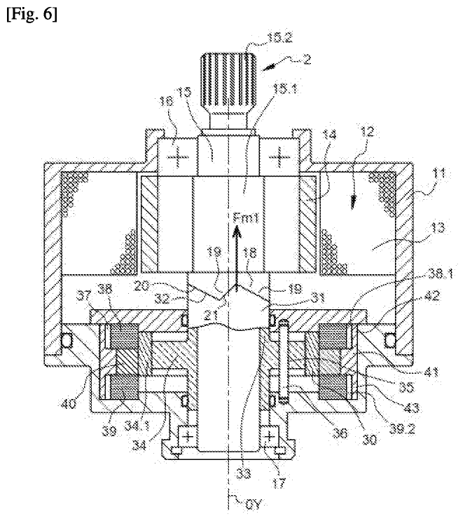

In a second embodiment, shown in FIG. 6, the electric motor 12 is located in the casing 11 between the shuttle 30 and the output 2 of the actuator 1.

Naturally, the invention is not limited to the embodiments described, but covers any variant coming within the ambit of the invention as defined by the claims.

In particular:
although above, the first and second sets of teeth comprise three triangular teeth, the invention applies equally to sets of teeth of other types, e.g. such as sets of teeth having one, two, four, or more teeth. The sets of teeth could be of some other profile, e.g. such as helical, sawtooth, or any other profile having at least one face lying in a plane intersecting the longitudinal axis, with the first angle between the first plane and the longitudinal axis lying in the range 5° to
although above, the shuttle comprises a central portion made of bronze and a ring of ferromagnetic material, the invention applies equally to other types of material for the shuttle, e.g. such a shuttle made entirely out of ferromagnetic material, or in which the central portion is made of non-magnetic stainless steel;
although above, the actuator has two coils, the invention applies equally to other types of selector mechanism for causing the shuttle to pass from its first position to its second position, e.g. such as a single coil, more than two coils, a fork acting mechanically on the shuttle, or a pusher;
although above, the actuator includes a permanent magnet acting on a ferromagnetic portion of the shuttle, the invention applies equally to other types of device for holding the shuttle in its first position, e.g. such as a spring or a stack of spring washers;
although above, the actuator includes a guide that is secured to the casing and on which the shuttle slides, the invention applies equally to other types of locking device for continuously preventing the shuttle from rotating relative to the casing, e.g. such as a shuttle provided with fluting co-operating with complementary fluting of the casing;
although above, the actuator rotates the nut, the invention applies equally to an actuator that rotates another element of the screw-and-nut assembly, e.g. such as the screw;
although above, the actuator includes a medium made of ferromagnetic material, the invention applies equally to an actuator having no such medium, the mere arrangement of the coils and of the permanent magnet sufficing to hold the collar in two stable states, namely a first state in which the collar is in its first position and a second state in which the collar is in its second position; and
although above, the guide is made of steel, the invention applies equally to a guide made of other materials, such as bronze or other nickel-copper-tin alloys.

1. A motor sub-assembly for an electromechanical brake actuator of an aircraft wheel, the motor sub-assembly comprising:
a casing;
a shaft mounted in the casing to rotate about a longitudinal axis of the shaft; and
an electric motor mounted in the casing and connected to a first end of the shaft in order to drive the shaft in rotation, the shaft having a second end arranged to be functionally connected to a movable element of a screw-and-nut assembly in order to exert a force on a stack of disks for braking the aircraft wheel,
wherein the shaft has a first set of teeth and the motor sub-assembly has a shuttle mounted to slide relative to the casing and provided with a second set of teeth for co-operating with the first set of teeth, and
wherein the motor sub-assembly includes a selector mechanism that moves the shuttle selectively between a first position in which the first set of teeth is engaged with the second set of teeth and a second position in which the first set of teeth is disengaged from the second set of teeth, and
wherein the motor sub-assembly includes a holder device that holds the shuttle in the first position and a locking device that continuously prevents the shuttle from rotating relative to the casing.

2. The motor sub-assembly according to claim 1, wherein the shuttle is mounted on the shaft to provide a sliding and pivoting connection relative to the shaft.

3. The motor sub-assembly according to claim 2, wherein the sliding and pivoting connection includes a central first portion that extends around a smooth portion of the shaft.

4. The motor sub-assembly according to claim 1, wherein the shuttle is mounted to provide a slideway connection relative to the casing.

5. The motor sub-assembly according to claim 1, wherein the selector mechanism comprises a first coil and a second coil.

6. The motor sub-assembly according to claim 1, wherein the locking device comprises at least one guide secured to the casing and on which the shuttle is guided to slide along a direction substantially parallel to the longitudinal axis.

7. The motor sub-assembly according to claim 1, wherein the shuttle comprises a first portion made of a non-ferromagnetic material and a second portion made of a ferromagnetic material.

8. The motor sub-assembly according to claim 1, wherein the shuttle is located in the casing between the electric motor and an output of the electromechanical brake actuator.

9. An motor sub-assembly according to claim 1, further comprising an additional holder device that holds the shuttle in its the second position.

10. The motor sub-assembly according to claim 1, wherein the holder device for holding the shuttle in its first position comprises a permanent magnet.

11. The motor sub-assembly according to claim 9, wherein the additional holder device comprises a permanent magnet.

12. The motor sub-assembly according to claim 1, wherein the first set of teeth and/or the second set of teeth includes a face lying in a first plane intersecting the longitudinal axis, and a first angle between the first plane and the longitudinal axis is in the range 5° to 85°.

13. The motor sub-assembly according to claim 1, wherein the electric motor is located in the casing between the shuttle and an output of the electromechanical brake actuator.

14. A brake actuator including the motor sub-assembly according to claim 1.

15. A braking system for an aircraft wheel, the braking system comprising a stack of disks having rotor disks constrained in rotation with the aircraft wheel and stator disks constrained in rotation with an axle on which the aircraft wheel is rotatably mounted, and the brake actuator according to claim 14,
wherein the brake actuator exerts a compression force on the stack of disks.

16. An aircraft including at least one wheel (10) provided with a braking system according to claim 15.

17. The motor sub-assembly according to claim 5, wherein the selector mechanism further comprises a collar, an annular support, and a lid.
